(19) United States
(12) Patent Application Publication
(10) Pub. No.: US 2024/0114170 A1
(43) Pub. Date: Apr. 4, 2024

(54) FEATURE RECONSTRUCTION USING NEURAL NETWORKS FOR VIDEO STREAMING SYSTEMS AND APPLICATIONS

(71) Applicant: Nvidia Corporation, Santa Clara, CA (US)

(72) Inventors: Aurobinda Maharana, Chinchwad (IN); Abhijit Patait, Pune (IN)

(21) Appl. No.: 17/955,754

(22) Filed: Sep. 29, 2022

(51) Int. Cl. H04N 19/70; G06T 5/50; G06T 7/246; G06T 7/60; G06V 10/25; G06V 10/82; G06V 40/16; H04N 7/15

(52) U.S. Cl. CPC H04N 19/70; G06T 5/50; G06T 7/246; G06T 7/60; G06V 10/25; G06V 10/82; G06V 40/161; H04N 7/15; G06T 2207/20132; G06T 2207/20221; G06V 2201/07

(57) ABSTRACT

Systems and methods relate to facial video encoding and reconstruction, particularly in ultra-low bandwidth settings. In embodiments, a video conferencing or other streaming application uses automatically tracked feature cropping information. A bounding shape size—used to identify the cropped region—varies and is dynamically determined to maintain a proportion for feature reconstruction, such as resizing in the event of a zoom-in on a face (or other feature of interest) or a zoom-out. The tracking scheme may be used to smooth sudden movements, including lateral ones, to generate more natural transitions between frames. Tracking and cropping information (e.g., size and position of the cropped region) may be embedded within an encoded bitstream as supplemental enhancement information (“SEI”), for eventual decoding by a receiver and for compositing a decoded face at a proper location in the applicable stream.

### BACKGROUND

Streaming media applications—such as applications for streaming video content related to video conferencing, gaming, television, and the like—have become increasingly popular as cloud infrastructures have become more commonplace. Remote working has further increased demand for streaming video content to facilitate everyday workplace interaction. However, streaming video content places a high demand for bandwidth on network infrastructure, which is further exacerbated by the inconsistent or poor network connection quality that commonly affect remote working environments.

Traditionally, streaming video services employ video compression solutions to reduce the amount of data communicated, thus reducing bandwidth requirements, and improving connection quality between video conferencing parties. Although compression solutions may reduce the impact of video streaming on bandwidth, some compression solutions may diminish the quality of the video content at the receiving end. Approaches that maintain high quality video are often very resource intensive, particularly for modern frame rates (e.g., 60 or more frames per second), which can be problematic for devices with limited resource capacity. For example, when reconstructing a face of a user—especially where the proportion of the facial portion of a frame is small compared to a background portion of the frame—the quality of facial reconstruction may be less than ideal. This degradation of facial reconstruction is especially problematic in video conferencing applications where the face of a speaker or other participant is the primary focus of the video stream—thus potentially creating a distraction and affecting the user experience.

To account for these drawbacks, prior attempts have cropped a fixed rectangular region around the face of a user in video content, and used the cropped frame as input for video encoding. For example, if the subject individual zooms in or zooms out, his or her face may consume a significantly larger or smaller portion of the input frame, causing the quality of the reconstruction to vary significantly. In addition, lateral and/or vertical motion of the face can cause the face to go out of the static cropped rectangle, thus limiting the movement of the user if a higher quality experience is to be maintained. In these prior approaches, the location and dimensions of the crop are not known at the receiving end, so when the cropped frame is used as foreground in a composited frame (e.g., within a virtual background) at the receiving end, the location and dimensions of the cropped frame may be static within the composited frame which may appear unnatural—especially as the user moves in and out of the fixed bounding rectangle and effectively disappears from the display.

### BRIEF DESCRIPTION OF THE DRAWINGS

Various embodiments in accordance with the present disclosure will be described with reference to the drawings, in which:

FIG. 1 is a block diagram illustrating an architecture for video streaming, such as video conferencing, between a sender and a receiver, in accordance with various embodiments;

FIG. 2 is a block diagram illustrating an architecture for video streaming, such as video conferencing, by a sender and a receiver using a computing resource services provider, in accordance with various embodiments;

FIGS. 3A-3C illustrate certain inputs and outputs used with object detection and display optimization techniques, in accordance with various embodiments;

FIG. 4 illustrates a process flow for neural network-based optimization of video content object tracking, in accordance with various embodiments;

FIG. 5 illustrates components of a system for processing video content, in accordance with various embodiments;

FIG. 6 illustrates a computer system, in accordance with various embodiments;

FIG. 7 illustrates components of a representative system, in accordance with various embodiments;

FIG. 8 illustrates at least portions of a graphics processor, in accordance with various embodiments; and

FIG. 9 illustrates at least portions of a graphics processor, in accordance with various embodiments.

### DETAILED DESCRIPTION

Approaches in accordance with various illustrative embodiments provide for neural network-assisted solutions for face tracking—and/or other feature tracking—in video streaming applications. While the term “video conference” appears herein, such is intended to be non-limiting, and the systems and methods described herein may be used with respect to any type of video content—such as video content related to gaming, television, broadcasts, remote desktop, and/or other applications where video encoding is used. Similarly, the term “face” is employed herein merely for convenience and without limitation, and wherever operations or discussion correspond to a face of an actor or subject, any other feature type (e.g., head, torso, limbs, tail, etc.) of any object or subject type (e.g., human, animal, robot, virtual character, etc.) may be used interchangeably without departing from the scope of the present disclosure.

The systems and methods described herein may be used for a variety of purposes, by way of example and without limitation, for synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications. Disclosed embodiments may be comprised in a variety of different systems such as automotive systems, systems implemented using a robot, aerial systems, medial systems, boating systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

Approaches described herein can use a dynamically resized bounding shape (e.g., box, rectangle, circle, polygon, etc.) for a face and/or other feature appearing in video content. To ensure encoding and reconstruction quality and efficiency, the bounding shape may be fitted to the face closely—such that the amount of background within the shape is reduced. As the face moves within the frame, the face may be tracked such that the bounding shape follows the face and is resized appropriately based on the current position of the face in the frame (e.g., if the face moves further from the camera, the bounding shape may decrease in size, and vice versa). In embodiments, as the face moves, the bounding shape may be resized such that a desired aspect ratio is maintained.

In some embodiments, the systems and methods described herein may be employed in an ultra-low bandwidth face encoding environment. The present systems and methods may be capable of operating in such ultra-low bandwidth for a variety of reasons described herein, while also maintaining a high-quality output stream after decoding. As non-limiting examples, the bandwidth required can be only one-fifth (⅕) or even one-tenth ( 1/10) of that required when performing H.264/MPEG-4 Advanced Video Coding (“AVC”) or H.265/High Efficiency Video Encoding (“HEVC”) encoding using typical processes.

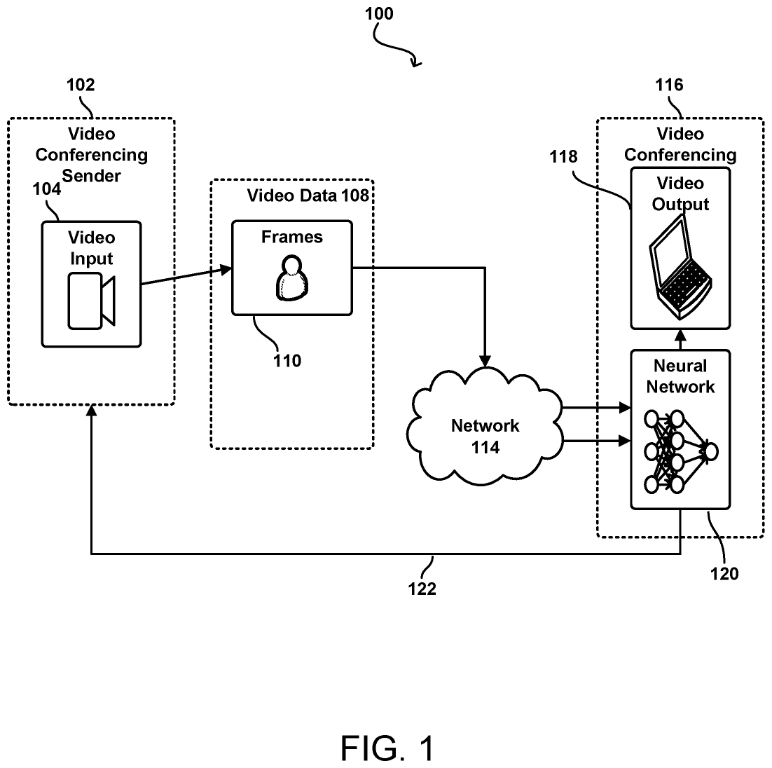

FIG. 1 is a block diagram illustrating a sample architecture 100 for video content streaming, such as video conferencing, between a sender 102 and a receiver 116 using at least one neural network 120, according to at least one embodiment. Such video streaming application broadly comprises video conferencing, teleconferencing, video game streaming and video game streaming services, digital satellite video streaming (such as digital satellite television streaming), broadcast video streaming, internet video streaming, digital video broadcasting, any Advanced Televisions Systems Committee (“ATSC”) approved television or other video broadcast technique (such as cable or broadcast television), any ATSC mobile/handheld (“ATSC-M/H”) video broadcast method, closed circuit television streaming and other closed circuit digital video capture or broadcast, video capture and encoding performed by personal digital cameras (such as digital single-lens reflex (“DSLR”) cameras) to store, encode, and transmit digital video data, and/or other video content streaming applications. The sample architecture 100 illustrated in FIG. 1 is usable for any video streaming and/or video capture application described herein or known to those in the art.

In at least one embodiment, the sender 102 is a computing system or any other computing device comprising one or more video input 104 devices, which generate or capture video data 108. The sender 102 can generate video data 108 using video capture or video streaming software, such as video game streaming software or video conferencing software. The sender 102 can comprise a single video input 104 device or a plurality of video input 104 devices to facilitate capture of image and video information. In at least one embodiment, the video data 108 is data comprising information usable to reconstruct or regenerate one or more (e.g., composited) images or video frames, where said information is generated, in part, by the video input 104 devices.

In at least one embodiment, a video input 104 device is a hardware device comprising one or more hardware components to capture image and video information; in the same or another embodiment, the video input 104 device is a software video capture program, such as a screen capture program or video conferencing program (potentially a video game streaming software program and/or a camera). The video input 104 device further can be any other type of device to capture image and video information. In some embodiments, one or more video input 104 devices capture or otherwise generate two-dimensional (2-D) images, video frames, or other information about one or more objects. In the same or other embodiments, one or more video input 104 devices capture or otherwise generate three-dimensional (3-D) images, video frames, or other information about one or more objects.

The one or more video input 104 devices capture or otherwise generate video frames 110, images, or other information about one or more objects usable as in connection with a bounding shape as contemplated herein. In at least one embodiment, a video frame 110 includes data representative of a single image or frame of video captured or otherwise generated by one or more video input 104 devices. The video frame 100 can be an image (e.g., a first image) in a sequence of images, such as a first frame in a sequence of video frames. The video frame 110 is a component of video data 108 usable for reconstruction or regeneration of one or more video frames on the receiver 116 side, such as by use of one or more neural networks 120. The frame 110 can be generated by one or more video input 104 devices as a result of a request to generate a new image, such as a new key frame (e.g., intraframe), by a receiver 116, leading to generation of a second image, or different image from a sequence of images, such as a different frame in a sequence of video frames.

Features about objects, points of interest, and the like can be represented in the video data 108. In at least one embodiment, points of interest comprise location and other information about features such as an eye, nose, jaw, mouth, or other facial features, and can further include information about hands, arms, or any other object features that indicate object position. The point of interest information may be usable to facilitate reconstruction of video frames.

The sender 102 transmits or otherwise communicates the video data 108 comprising one or more frames 110, in an embodiment, over a network 114, to one or more receivers 116. The network 114 is a communication medium between two or more computing systems to facilitate exchange of data or other information between said two or more computing systems. The network 114 can comprise a wide-area network (“WAN”), a local area network (“LAN”), hardware and/or software to facilitate peer-to-peer data exchange over a wireless communication protocol such as Bluetooth™ or any near-field communication (“NFC”) protocol, hardware and/or software to facilitate Internet communication, and/or any other hardware and/or software to facilitate exchange of data or other information between one or more senders 102 and one or more receivers 116 over one or more networks 114.

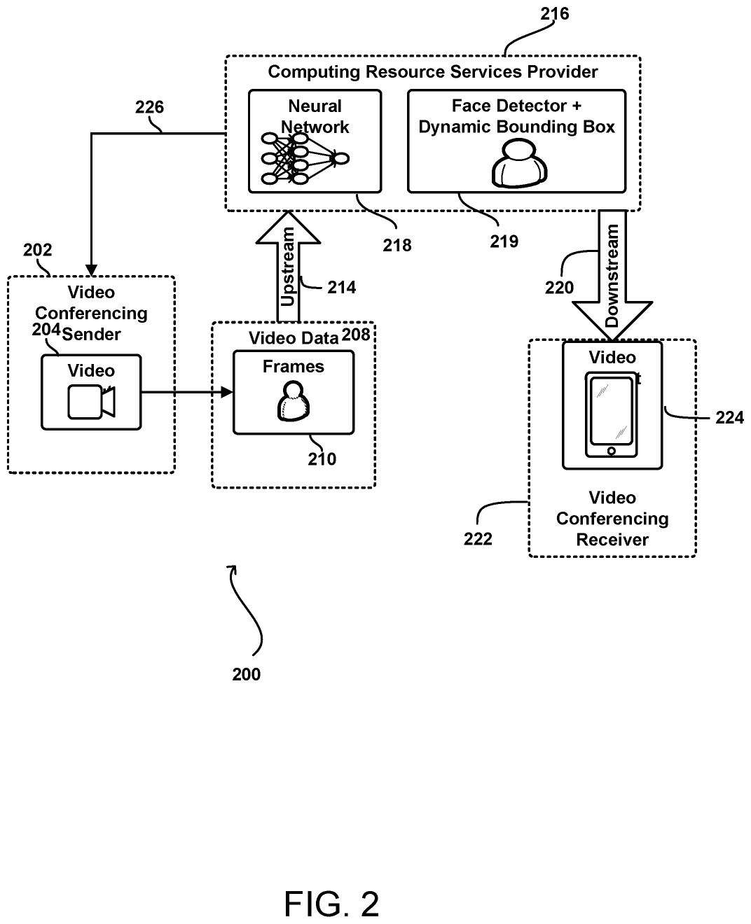

In at least one embodiment, the receiver 116 receives the video data 108 transmitted over the network 114 and reconstructs, using at least one neural network 120, video content for a video output 122. The receiver 116 can be a computing system or computing device such as a laptop or desktop computer, a tablet, or any other stationary or mobile personal or cloud-based computing device including, or in communication with, one or more video outputs 122. In some embodiments, the receiver 116 is a computing resource services provider, as described below in conjunction with FIG. 2. The video output 118 device is one or more graphics processors or graphics rendering devices capable of rendering video for display on one or more video displays. The video output 118 devices or components receive video frames 110 or other video data 108 to be output for display on one or more video displays from the at least one neural network 120.

In at least one embodiment, the neural network 120 includes data values and software instructions that, when executed, reconstruct or otherwise infer one or more video frames (or portions thereof) to be displayed by one or more video output devices 118 based on the frames 110, points of interest, etc. As discussed herein, the neural network 120 can infer, generate, or otherwise reconstruct one or more 2-D and/or 3-D video frames, using a frame 110 as a base image in conjunction with point of interest or feature information to indicate updates to the frame 110.

The neural network 120 may move, rotate, or otherwise adjust one or more 2-D and/or 3-D characteristics or features of a displayed sender 102, such as a face of a user, based on video data 108 and the dynamic bounding shape(s) disclosed herein. In doing so, the neural network 120 may apply one or more visual adjustments or modifications to one or more video frames generated, inferred, or otherwise reconstructed by the neural network 120. Temporal upsampling is usable to generate additional images or video frames by the neural network 120 by interpolating between different received sets of features, points of interest, and/or landmarks. The neural network 120 can be configured to apply style mixing to sharpen motion blurred portions of one or more images or video frames generated or otherwise inferred by the neural network 120.

In at least one embodiment, the neural network 120 segments the video frames 110 into foreground and background components, potentially reflecting user-added overlays and the like. In at least one embodiment, the neural network 120 generates or otherwise creates one or more modified video frames indicated by one or more users of a receiver 116, potentially including so-called deep fakes, indicating one or more alternative objects not captured or otherwise observed by the video input 104 devices. For example, in an embodiment, one or more alternate objects are cartoon or video game representations.

FIG. 2 is a block diagram illustrating an architecture 200 for video processing and streaming, such as in a video conferencing setting, by a sender 202 and a receiver 222 using a computing resource services provider 216 comprising at least one neural network 218. The sender 202 may be a computing system or computing device having one or more users and comprising one or more video input 204 devices, as described above in conjunction with FIG. 1. In at least one embodiment, the sender 202 generates, infers, or otherwise creates video data 208 comprising one or more video frames 210, as described above in conjunction with FIG. 1.

The sender 202 transfers, sends, or otherwise communicates video data 208 to a computing resource services provider 216 using an upstream 214 communication channel, such as is network infrastructure (including that described herein). This communication facilitates the transfer of the video data 208 from the sender 202 to one or more network servers accessed by the computing resource services provider 216. The upstream 214 communication channel allows uploading of data between a sender 202 and a computing resource services provider 216. The upstream 214 communication channel, in various embodiments, may have equivalent or reduced bandwidth capabilities when compared to a downstream 220 communication channel. The upstream 214 communication channel may comprise one or more of a wired network connection and/or a wireless network communication channel. In at least one embodiment, the sender 202 transfers data to the computing resource services provider 216 over an upstream 214 communication channel comprising a single communication channel between a client and server on a network, while other embodiments may use multiple communication channels between multiple clients and servers on a network. The upstream 214 communication channel can comprise, additionally or alternatively, any network topography to facilitate client-server or peer-to-peer communication over a network.

In at least one embodiment, the computing resource services provider 216 includes one or more computing systems to provide computing services over a network, including any service described herein. The computing resource services provider 216 can comprise or apply one or more neural networks 218 to facilitate inferencing, reconstruction, and/or any other generation of video frames from video data 208, including conversion of the video data 208 to video frames or other data using the one or more neural networks 218, as described herein. The computing resource services provider 216 applies facial detecting and dynamic bounding shape 219 techniques and approaches described herein in processing the video data 208 and optimizing related output. The computing resource services provider 216 may comprise one or more parallel processing units (“PPUs”), such as graphics processing units (“GPUs”) and/or data processing units (“DPUs”), to improve inferencing performance of the one or more neural networks 218. The computing resource services provider 216 can also transfer or otherwise communicate video data generated or otherwise inferred by its one or more neural networks 218 to a receiver 222 using a downstream 220 communication channel.

In at least one embodiment, the downstream 220 communication channel is network infrastructure to facilitate downloading and/or other transfer of data from one or more network servers in a computing resource services provider 216 to a receiver 222, as described above in conjunction with FIG. 1. The downstream 220 communication channel can be one or more of a wired network connection and/or a wireless network communication channel, comprising one or more communication channels between a client and server on a network. The downstream 220 communication channel may comprise topography to facilitate client-server or peer-to-peer communication on a network. In at least some embodiments, the receiver 222 is the same party as the sender 202.

In various embodiments, the receiver 222 receives data comprising video frames or other data to represent video from the sender 202 as processed and/or optimized by the computing resource services provider 216. The receiver 222 may include a computing system or computing device comprising one or more video output 224 devices, including desktop or laptop computing devices, mobile devices (such as tablets or mobile phones), or any other type of computing system capable of receiving data comprising video from the computing resource services provider 216.

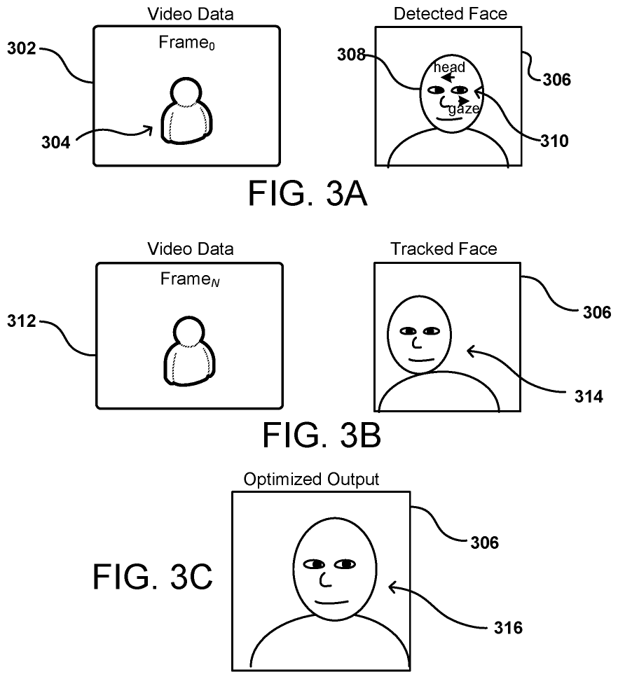

As depicted in FIGS. 3A-3C, in various illustrative embodiments, the present systems and methods apply a dynamically sized bounding shape or outer window cropped after initially detecting a face (or any other feature of any object of interest) in video content represented by video data. For example, facial features within an identified face region can be detected for individual images (or video frames) in a sequence for use in reconstructing those images (or video frames). Typical video encoding uses a fixed crop for bounding boxes, but this is problematic in at least a couple of common scenarios: the appearance of the face in a zoom-in or zoom-out situation, and the face moving outside of the cropped window following a larger-magnitude movement. In contrast, the presently applied dynamic bounding shape can keep an identified face substantially centered in a bounding shape or cropped region, facilitated by related information sent—for every frame, in some embodiments—to the decoder through a Supplemental Enhancement Information (“SEI”) message.

For example, a face (and/or other feature(s)) of an object or subject may be tracked across multiple frames in order to generate a bounding shape that bounds the face of the object or subject. The bounding shape may be variable and thus dynamically generated for different frames—e.g., each frame, every x number of frames, after a threshold change in size/location of the face is determined, etc.—such that the bounding shape is more accurately proportioned relative to the face of the object or subject as the object of subject moves laterally left to right, longitudinally back to front, and/or vertically up and down. For example, as a subject moves to the left, right, up, or down, the bounding shape may move with the user. As another example, as the subject moves forward and backward, the bounding shape may be resized (e.g., made wider and/or taller as the subject moves closer to the reference camera, or made narrower and/or shorter as the subject moves further from the reference camera).

As such, as the tracked location of the face of the subject moves, the bounding shape may move with the subject. The portion of the image(s) within the bounding shape may be cropped, and the cropped portion of the image(s) may be encoded as the image(s) or video corresponding to the face of the subject at each frame. In addition, to allow for accurate reconstruction at the receiving end, information corresponding to the bounding shape—e.g., dimensions (e.g., height, width, reference point—such as a centroid of the bounding shape, or a corner(s) of the bounding shape) and/or location (e.g., relative location of the bounding shape within the larger pre-cropped frame) may be encoded in a message (e.g., a SEI message) along with the encoded frame(s). As such, upon receipt of the encoded frame(s) and the message at the receiving end, a composite frame may be generated including the cropped image of the subject's face (and/or other features) as the foreground, along with a background (e.g., a virtual background), where the foreground may be positioned in the composited frame in a same or similar location as in the pre-cropped frame prior to encoding. In this way, the appearance and location of the foreground may be consistent with the original appearance and location at capture time, thus allowing for a more natural and seamless display.

One or more of such systems, methods, detections, or boxes may be performed by a computing resource service provider such as that shown in FIG. 2. An amount of processing to be performed can be reduced by detecting a region of interest for an individual image, such as a face region determined using any of a number of different face detection algorithms or techniques (including via a service provider face detector component or module) to be executed on each of these images, regardless of whether there is significant movement between frames. The amount of processing can be further reduced by using image features, identified within a face region of a given frame, to predict a face region in a next frame in a same sequence. For example, video data can be received, such as in FIG. 3A, which represents a first frame 302 (of a sequence of frames) including a representation 304 of at least a portion of an actor, subject, organism, or object, such as a person.

In conjunction with use of a dynamic bounding shape 306, a face detector module, component, and/or algorithm (not shown) can be executed on, and analyze, the first frame 302 to identify a face 308, or head in general, as well as any of a number of facial features 310 within the facial region. When deciding a border of the bounding shape 306, in illustrative embodiments, the size is not fixed, but will account for and include space around a detected face. If a sufficient spatial margin around the face is not included in the video data received by the service provider, the systems and methods herein can be configured to lessen the margin as needed around the face, to standardize the margin or even create some new space to surround the face. As such, the bounding shape can be composited or resized depending on what may be required in the content, and may be recomposited in a more proper location to provide a better quality frame for a given bandwidth.

In some embodiments, the dynamic bounding shape 306 includes, or at least is within, a cropped area (which may be any of a number of shapes, including a rectangle) outside the bounds of a separate face tracking window, which may not visible for the end-user and may not track the face on a pixel-by-pixel, or even frame-by-frame, basis. To calculate the dynamic cropping bounding box 306 with variable dimensions, face detection may be performed as a first operation for each frame, with a fixed bounding shape added around the face 308. A second operation tracks the face 308, should it have moved, and stabilizes it to avoid causing any inadvertent movement of the torso when rendering; in some embodiments, this can entail finding the center of the face and cropping with a fixed margin initially

In some embodiments, the face detector may provide what is essentially a complete border of the face 308, and a centroid of those border points can be used for tracking. For example, a nose on a subject face may be where the centroid lies. The tracking may, also or alternatively, be based on a point, facial or otherwise, that is something other than the center of the face, including one or more key points or area delimiters along or on the face and/or around the perimeter of the head.

In determining the facial features 310, the processing and/or analyses may be performed on only a portion of the first frame 302 that corresponds to the determined face 308 region. In at least one embodiment, this may include cropping the first frame 302 to the face 308 region and considering only the cropped portion. The detected facial features 310 or other key points should suffice for image synthesis or reconstruction, as they can be used to determine movement of the face 308 of the person, as well as eyes in embodiments where separate gaze tracking is used. Facial features 310 identified may include any appropriate features or key points useful in performing image reconstruction and are not limited to well-understood facial features or landmarks. The detected face 308 region may further include a portion or subset of pixels in the frame 302, potentially with gaze tracking and/or a buffer on an order of around a few pixels around these face pixels to account for some amount of noise or variance.

In various illustrative embodiments, an output of a face detection algorithm may include coordinates of the dynamic bounding shape 306 around the face region, among other boundary designations. In at least one embodiment, the facial feature 310 positions can then be used to establish an initial size and/or position for the dynamic bounding shape 306. The initial size and position of the dynamic bounding shape 306 and the face 308 region may be employed in processing for subsequent video frames until there is a scene change or more than a threshold amount of motion, for example, at which time a face detection algorithm may be run on a next frame, such as that in video data 312 shown in FIG. 3B.

When the face 308 is currently inside the tracking window, because the window is allowed to move slowly, the face 308 may not necessarily be exactly at the center of the bounding shape 306; however, with a relative face 308 position, it is possible to find the motion of the bounding shape 306. The tracking window, in some embodiments, may be configured such that the subject face 308 stays within the bounding shape, while maintaining a smooth and linear movement for display.

The facial tracking mechanisms herein may avoid hysteresis, meaning a lag between input and output in a system upon a change in direction. This is accomplished, at least in part, due to tracking the position of the face 308 (such as its center) as a parameter in each frame and comparing such current position to the position found in a later frame. How rapidly the bounding shape 306 will move in comparison to the tracked face 308 can be based on how quickly the face 308 has moved over a predetermined number of prior frames, such as the five or ten most recent frames. In some embodiments, one or more non-linear or exponential formulas or equations (known to those in the art) can be applied to calculate and drive how much the tracking window should move, in order to minimize the display of sudden movements and keep the subject face inside the cropped bounding shape 306, based on one or more tracked points (such as the center of the face 308). A facial (or even full head) motion average can be computed and applied in connection with such formulas or equations; for example, if a given face motion average is on a downward trend during a video conference, then the bounding shape 306 can automatically move slowly, compared to the face 308 movement.

In this fashion, by applying a motion average, compensation can be made for small motions, which may be ignored. If the motion is more substantial, a parameter may be provided to decide how much movement should be permitted for display. In some embodiments, the average is used in connection with a non-linear exponential equation. Sudden face 308 or other movements can cause the bounding shape 306 to move faster. The space surrounding the face 308 ideally is kept uniform. Even in cases of extreme face 308 movement, the face 308 will usually not fall outside of the bounding shape 306, which may be ensured by a heuristically-applied buffer of space, such as at least a fifteen percent (15%) threshold, between the face 308 and the border of the bounding shape 306. Such a buffer or threshold count can be measured in pixels, including those determined and counted using a face detector.

Analyzing changes in feature position from two or more frames can help determine motion of the face 308 with respect to a camera view, as may be due to motion or adjustment of this face or this camera, or both. Accordingly, as depicted in FIG. 3B, a next image 312 in this sequence can be received or obtained, and locations of a face and/or features thereof in a prior image (such as shown in FIG. 3A) can be used in conjunction with the dynamically sized bounding shape 306. In this next image, the new position 314 of the tracked face can differ from the FIG. 3A prior face region.

Based on new locations 314 of one or more of a face, features, and/or key points, at least a subset of the features 310 identified in the FIG. 3A image may still be visible in a face region of this subsequent image 312; this means that an iteration of the bounding shape 306 can be similar, if not exactly the same as, to bounding shape 306 as shown in in FIG. 3A. In at least one embodiment, such detection and tracking process can continue for any number of additional frames. Use of prior frame data may be differently weighted or decayed over time, such that more recent data is considered more heavily as a direction or amount of motion can change over time, such that more recent position data should be given more consideration that position data further back in a sequence.

FIG. 3C illustrates how the present optimization systems and methods can automatically adjust the size of the bounding shape 306, making it larger in this case, and can center the location 316 of the tracked face therein. On the decoder side, it may be known where the video crop is made, so the background is known and capable of separation for analytical purposes. Even with the various determinations and calculations performed herein, latency be less of a concern as processing may be on the order of 33 milliseconds for a single frame.

In-band information may be embedded in the bitstream. The cropped rectangle, as reflected by the dynamic bounding shape 306 in some embodiments, will have a height and width which can be expressed in terms of X-Y coordinates and included in-band as SEI information, going to the client device side. This will allow a client device to composite and properly position the display of a face or other object of interest.

The present techniques can accommodate a variety of bandwidth settings, including the often-encountered 512 Kbps and anything less than 70 Kbps. While the systems and methods described herein are particularly useful in lower-bandwidth settings, even in higher-bandwidth settings, providers will find considerable benefits in region of interest encoding, such as can be performed as part of HEVC or H.264 encoding. For example, the provider can invest more bit processing efforts on a region of interest without any loss as to other regions, including where the provider considers an entire frame as the region of interest, but spend more bits on a face or other region of interest.

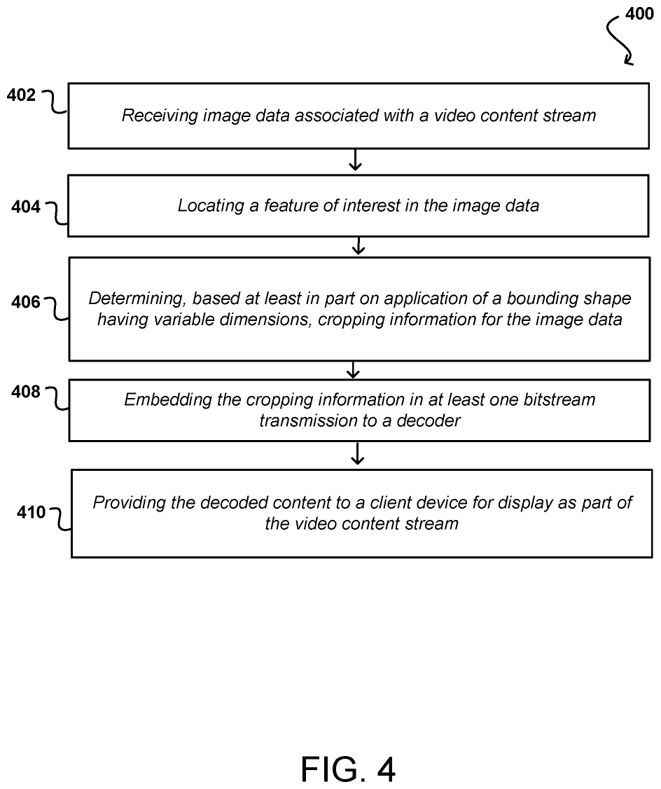

A sample process flow 400 is presented in FIG. 4 and commences with the operation of receiving 402 image data associated with a video content stream. Again, such image data may be received by a service provider and come from a video data sender (such as in the video conferencing context) using a camera, webcam, or other device to capture video data as contemplated herein.

A feature of interest may be located 404 on an object in an image represented by the image data, such as within a frame of the image data. In doing so on the service provider side, as noted, a face detector component or module can be executed, yielding what can be a tightly fit bounding shape around the face (and/or other feature). As noted, alternative applications besides tracking a face are contemplated and within the scope of embodiments described herein. For example, the tracking can be directed to any feature(s) of any object(s) of interest.

Cropping information is then determined 406, based at least in part on application of a bounding shape having variable dimensions. The border determination and object tracking will decide a suitable cropping area, with the non-facial background handled separately, potentially on a lower video quality level. Of note, if the client on the sender side is using a substituted background for the video, the provider can detect that and remove the substitute background from the analyses and not send data regarding the same back to the client as part of the return, downstream transmissions.

The cropped bounding shape with the background removed will be passed to an encoder component or module, which can generate the final bitstream that includes embedded 408 SEI messages for transmission to a decoder. Encoding can be performed using any of a number of codecs, including H.264 and HEVC, as well as the Face Codec from NVIDIA Corp. of Santa Clara, California. For example, cropping may be performed, based at least on the cropping information, for a frame of the image data to generate a cropped frame. Then, encoding may be performed for the cropped frame and the cropping information for transmission in at least one bitstream using, in part, embedded all or part of such cropped frame (or related information) and cropping information in the SEI.

The cropping information, including the embedded SEI messages, may be provided 410 to a client device, as decoded content, after decoding in a decoder. The client device can properly composite the face, including its scale and location, based on the bitstream and SEI messages, potentially with the background subtracted as noted. Using the systems and methods herein, the movement displayed on the client side may seem natural, without trying to precisely keep the face in the center with no movement thereof. Horizontal, vertical, and/or zooming movements are shown on the client device, albeit without allowing the face to go out of the window.

Components and hardware used by a service provider side include a face detector or any other facial recognition software development kit (“SDK”), A content application (e.g., a gaming or streaming media application) executing on a content server may initiate a session associated with at least one client device, as may use a session manager and user data stored in a user database, and it can cause content to be determined by a content manager and rendered using a rendering engine, and transmitted to the client device using an appropriate transmission manager to send by download, streaming, and/or another transmission channel. The client device receiving this content can provide the content to a corresponding content application, which may also or alternatively include a rendering engine for rendering at least some of this content for presentation via the client device, such as video content through a display and audio. At least some of this content may already be stored on, rendered on, or accessible to the client device such that transmission over a network is not required for at least that portion of content.

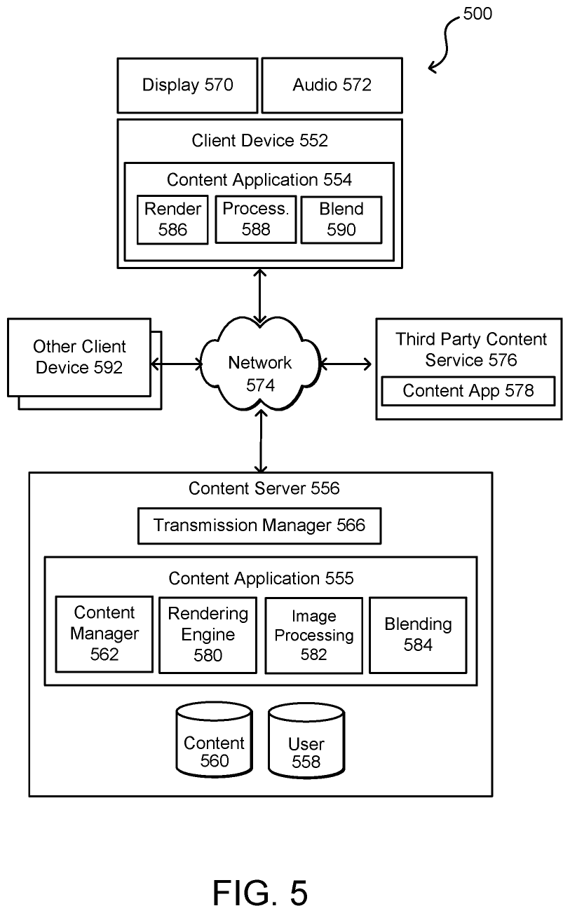

In this vein, FIG. 5 shows some components of a system 500 for processing video content. In at least one embodiment, a client device 552 can generate the content for a session, such as a video conferencing or gaming session, using components of a content application (e.g., a gaming or streaming media “app”) 554 executing on the client device 552 and data stored locally on the client side. A related version 555 of the content application executing on a content server 556 may initiate a session associated with the client device 552, as may use a session manager and user data stored in a user database 558. The content app 554 can cause content 560 to be determined by a content manager 562 and rendered using a rendering engine 564, if needed for this type of content or platform, and transmitted to client device 552 using an appropriate transmission manager 566 to send by download, streaming, and/or another such transmission channel. The receiving client device 552 can provide this content to a corresponding content application 554, which may also or alternatively include a rendering engine 568 for rendering at least some of this content for presentation via the client device 552, such as video content through a display 570 and audio, such as sounds and music, through at least one audio playback device 572, such as speakers, headphones, or ear buds.

At least some of the provided content may already be stored on, rendered on, or accessible to client device 552 such that transmission over a network 574 is not required for at least that portion of the content, such as where that content may have been previously downloaded or stored locally on a hard drive, optical disk, or solid state drive. A transmission mechanism such as data streaming can be used to transfer this content from the server 556, or content database 560, to client device 552. In at least one embodiment, at least a portion of this content can be obtained or streamed from another source, such as a third-party content service 576 that may also include a content application 578 for generating or providing content.

Portions of this functionality can be performed using multiple computing devices, or multiple processors within one or more computing devices, such as may include a combination of central processing units (“CPUs”), graphics processing units (“GPUs”), and/or data processing units (“DPUs”). Some embodiments use NVIDIA Pascal ray tracing and/or Turing-based GeForce architecture. In at least one embodiment, a renderer may be part of a rendering pipeline, such as may use rendering software such as Unreal Engine 4 from Epic Games, Inc., that can provide functionality such as deferred shading, global illumination, lit translucency, post-processing, and GPU particle simulation using vector fields.

In some illustrative embodiments, the content application 555 includes a content manager 562 that can determine or analyze content before this content is transmitted to the client device 552. The content manager 562 can also include, or work with, other components that are able to generate, modify, or enhance content to be provided; this can include a rendering engine 580 for rendering content. An upsampling or scaling image processing component 582 can generate at least one additional version of this image content at a different resolution, higher or lower, and can perform at least some processing such as anti-aliasing. A blending component 584, as may include at least one neural network, can perform blending for one or more images with respect to prior images, as discussed herein. The content manager 562 can then select an image or video frame of an appropriate resolution to send to client device 552. The content application 554 on the client device 552 may also include components such as a rendering engine 586, an upsampling and/or other processing module 588, and a blending module 590, such that any or all of this functionality can additionally, or alternatively, be performed on the client device 552. A content application 578 on a third-party content service system 576 may also include such functionality.

It may be desirable to further reduce processing, memory, and other resources used in processes as deemed appropriate. In at least one embodiment, images and input provided to a neural network can first be downsampled in order to operate the neural network at a lower resolution. The neural network can be trained at full resolution or reduced resolution, but, at an inference time, can execute at reduced resolution. Output of the neural network can be upsampled before applying for blending and filtering. As is known in the neural network and artificial intelligence arts, a variety of neural network types may be applied by the service operator, including, but by no means limited to, feedforward, recurrent, radial basis function, modular, and self-organizing neural networks.

In at least one embodiment, the system 500 can include any appropriate combination of hardware and software in one or more locations. The locations where at least some of this functionality is performed may be configurable, or may depend upon factors such as a type of client device 552 or availability of a network 574 connection with appropriate bandwidth, among other such factors. Generated image or video content of one or more resolutions can also be provided, or made available, to other client devices 592, such as for download or streaming from a media source storing a copy of that image or video content.

A renderer may instead be used to generate a rendered image at a resolution that lower than one or more final output resolutions, such as to meet timing requirements and reduce processing resource requirements. This low-resolution rendered image can be processed using an upscaler to generate an upscaled image that represents content of low resolution rendered image at a resolution that equals (or is at least closer to) a target output resolution.

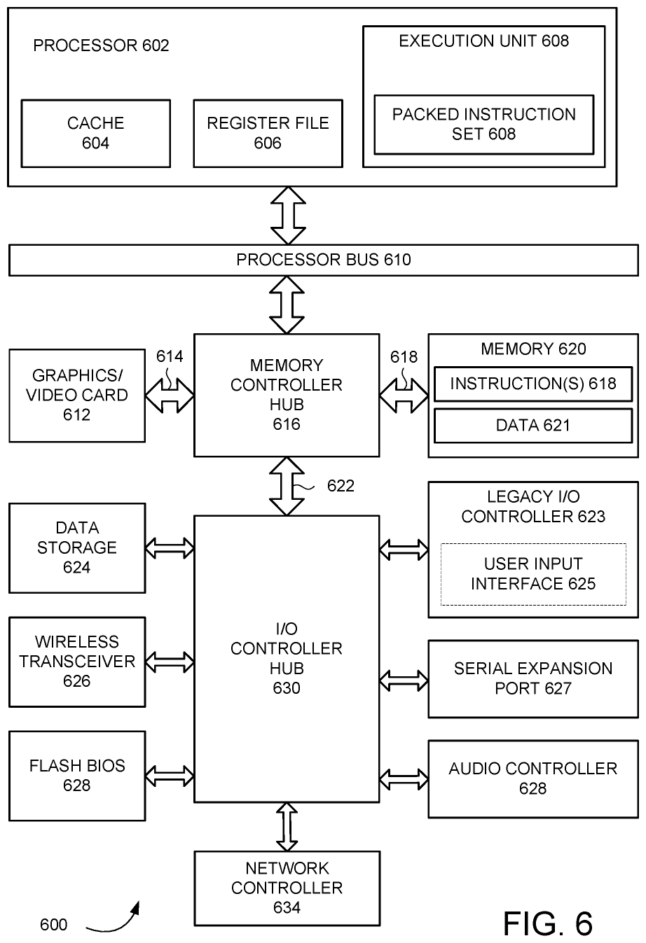

FIG. 6 is a block diagram illustrating an exemplary computer system 600, which may be a system with interconnected devices and components, a system-on-a-chip (“SOC”) or some combination thereof formed with a processor that may include execution units to execute an instruction, according to at least one embodiment. The computer system 600 may include, without limitation, a component, such as a processor 602 to employ execution units including logic to perform algorithms for process data, in accordance with present disclosure, such as in embodiments described herein. The computer system 600 may include processors, such as that in the PENTIUM® Processor family or the Xeon™, Itanium®, XScale™ and/or StrongARM™ Intel® Core™, or Intel® Nervana™ microprocessors available from Intel Corp. of Santa Clara, California, although other systems (including PCs having other microprocessors, engineering workstations, set-top boxes and the like) may also be used. The computer system 600 may execute a version of WINDOWS® operating system available from Microsoft Corp. of Redmond, Washington, although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. Embedded applications may include a microcontroller, a digital signal processor (“DSP”), system on a chip, network computers (“NetPCs”), edge computing devices, set-top boxes, network hubs, WAN switches, or any other system that may perform one or more instructions in accordance with at least one embodiment.

The computer system 600 may include, without limitation, a processor 602 including, without limitation, one or more execution units 608 to perform machine learning model training and/or inferencing according to techniques described herein. In at least one embodiment, the computer system 600 is a single processor desktop or server system, but, in another embodiment, the computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. The processor 602 may be coupled to a processor bus 610 that may transmit data signals between the processor 602 and other components in the computer system 600.

The processor 602 may include, without limitation, a Level 1 (“L1”) internal cache memory (“cache”) 604, and the processor 602 may have a single internal cache or multiple levels of internal cache. Cache memory may reside external to the processor 602. Other embodiments may also include a combination of both internal and external caches depending on particular implementation and needs. A register file 606 may store different types of data in various registers including, without limitation, integer registers, floating point registers, status registers, and instruction pointer registers.

An execution unit 608, including, without limitation, logic to perform integer and floating point operations, also resides in the processor 602. The processor 602 may also include a microcode (“ucode”) read only memory (“ROM”) that stores microcode for certain macro instructions. The execution unit 608 may include logic to handle a packed instruction set 609. By including packed instruction set 609 in an instruction set of a general-purpose processor 602, along with associated circuitry to execute instructions, operations used by many multimedia applications may be performed using packed data in the general-purpose processor 602. Many multimedia applications may be accelerated and executed more efficiently by using full width of a processor's data bus for performing operations on packed data, which may eliminate the need to transfer smaller units of data across processor's data bus to perform one or more operations one data element at a time.

The execution unit 608 may also be used in microcontrollers, embedded processors, graphics devices, DSPs, and other types of logic circuits. The computer system 600 may include, without limitation, a memory 620, implemented as a Dynamic Random Access Memory (“DRAM”) device, a Static Random Access Memory (“SRAM”) device, flash memory device, or other memory device. The memory 620 can store instruction(s) 619 and/or data 621 represented by data signals that may be executed by the processor 602.

A system logic chip may be coupled to a processor bus 610 and memory 620. The system logic chip may include, without limitation, a memory controller hub (“MCH”) 616, and the processor 602 may communicate with the MCH 616 via the processor bus 610. The MCH 616 may provide a high bandwidth memory path 618 to the memory 620 for instruction and data storage and for storage of graphics commands, data, and textures. The MCH 616 may direct data signals between processor 602, memory 620, and other components in computer system 600 and to bridge data signals between processor bus 610, memory 620, and a system I/O 622. A system logic chip may provide a graphics port for coupling to a graphics controller. The MCH 616 may be coupled to memory 620 through a high bandwidth memory path 618, and a graphics/video card 612 may be coupled to MCH 616 through an Accelerated Graphics Port (“AGP”) interconnect 614.

The computer system 600 may use system I/O 622 that is a proprietary hub interface bus to couple the MCH 616 to an I/O controller hub (“ICH”) 630. The ICH 630 may provide direct connections to some I/O devices via a local I/O bus. The local I/O bus may include, without limitation, a high-speed I/O bus for connecting peripherals to the memory 620, a chipset, and the processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as Universal Serial Bus (“USB”), and a network controller 634. The data storage 624 may comprise a hard disk drive, a floppy disk drive, a CD-ROM device, a flash memory device, or other mass storage device.

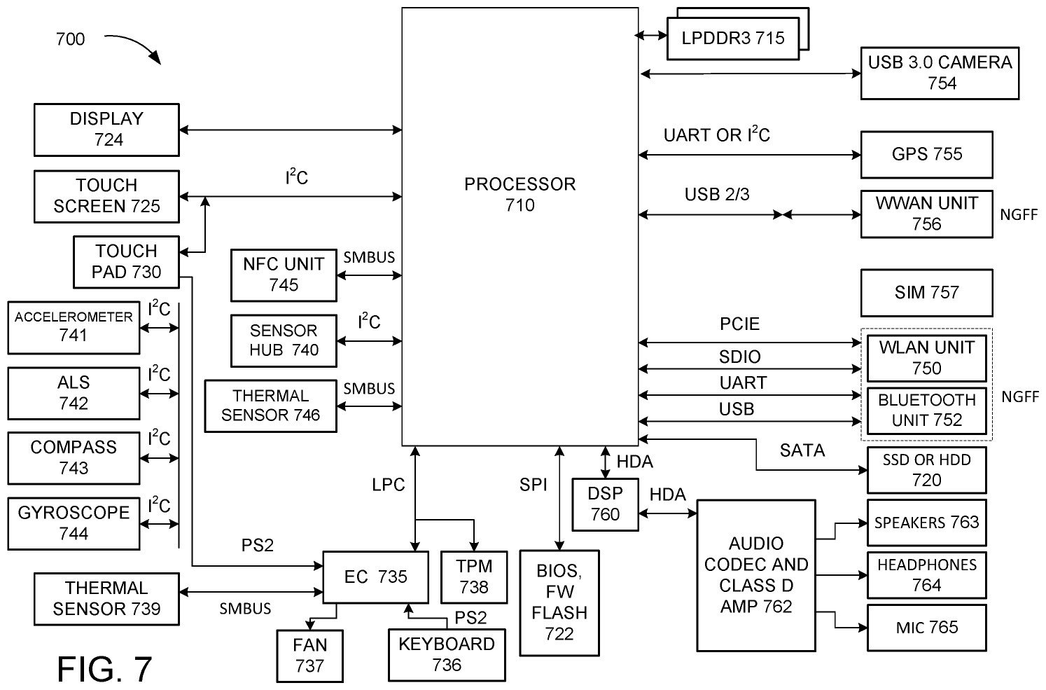

FIG. 7 is a block diagram illustrating an electronic device 700 for utilizing a processor 710, according to at least one embodiment. The electronic device 700 may be, for example and without limitation, a notebook, a tower server, a rack server, a blade server, a laptop, a desktop, a tablet, a mobile device, a phone, an embedded computer, or any other suitable electronic device. The device 700 may include, without limitation, a processor 710 communicatively coupled to any suitable number or kind of components, peripherals, modules, or devices. The processor 710 may be coupled using a bus or interface, such as a 1° C. bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus.

In at least one embodiment, FIG. 7 illustrates a system, which includes interconnected hardware devices or “chips,” whereas in other embodiments, FIG. 7 may illustrate an exemplary System on a Chip (“SoC”). Devices and components illustrated in FIG. 7 may be interconnected with proprietary interconnects, standardized interconnects (e.g., PCIe) or some combination thereof. In at least one embodiment, one or more components of FIG. 7 are interconnected using compute express link (“CXL”) interconnects.

FIG. 7 includes a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (“GPS”) 755, a camera (“USB camera”) 754 such as a USB 3.0 camera, and/or a Low Power Double Data Rate (“LPDDR”) memory unit (“LPDDR3”) 715 implemented in, for example, LPDDR3 standard. These components may each be implemented in any suitable manner.

Other components may be communicatively coupled to the processor 710 through components discussed herein. An accelerometer 741, Ambient Light Sensor (“ALS”) 742, compass 743, and a gyroscope 744 may be communicatively coupled to sensor hub 740. A thermal sensor 739, a fan 737, a keyboard 746, and a touch pad 730 may be communicatively coupled to EC 735. A speaker 763, headphones 764, and microphone (“mic”) 765 may be communicatively coupled to an audio unit (“audio codec and class d amp”) 762, which may, in turn, be communicatively coupled to a DSP 760. An audio unit 764 may include, for example and without limitation, an audio coder/decoder (“codec”) and a class D amplifier. A SIM card (“SIM”) 757 may be communicatively coupled to a WWAN unit 756. Components such as WLAN unit 750 and Bluetooth unit 752, as well as the WWAN unit 756 may be implemented in a Next Generation Form Factor (“NGFF”).

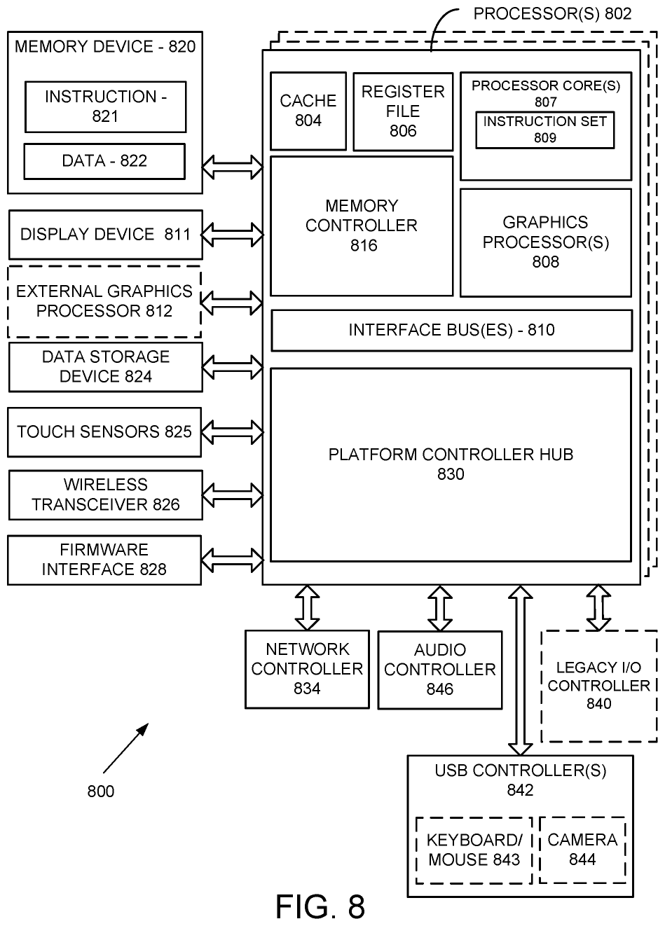

FIG. 8 is a block diagram of a processing system 800, according to at least one embodiment. The system 800 includes one or more processors 802 and one or more graphics processors 808, and may be a single processor desktop system, a multiprocessor workstation system, or a server system or datacenter having a large number of collectively or separably managed processors 802 or processor cores 807. The system 800 can be a processing platform incorporated within a system-on-a-chip (“SoC”) integrated circuit for use in mobile, handheld, or embedded devices.

The system 800 can include, or be incorporated within a server-based gaming platform, a cloud computing host platform, a virtualized computing platform, a game console, including a game and media console, a mobile gaming console, a handheld game console, or an online game console. In at least one embodiment, the system 800 is a mobile phone, smart phone, tablet computing device or mobile Internet device. The processing system 800 can also include, couple with, or be integrated within a wearable device, such as a smart watch wearable device, smart eyewear device, augmented reality device, edge device, Internet of Things (“IoT”) device, or virtual reality device. The processing system 800 may be a television or set top box device having one or more processors 802 and a graphical interface generated by one or more graphics processors 808.

The one or more processors 802 each include one or more processor cores 807 to process instructions which, when executed, perform operations for system and user software. Each of one or more processor cores 807 may be configured to process a specific instruction set 809. The instruction set 809 may facilitate Complex Instruction Set Computing (“CISC”), Reduced Instruction Set Computing (“RISC”), or computing via a Very Long Instruction Word (“VLIW”). The processor cores 807 may each process a different instruction set 809, which may include instructions to facilitate emulation of other instruction sets. The processor cores 807 can also include other processing devices, such a Digital Signal Processor (“DSP”).

The processor 802 can include cache memory 804, and the processor 802 may have a single internal cache or multiple levels of internal cache. In at least one embodiment, cache memory is shared among various components of processor 802. The processor 802 also uses an external cache (e.g., a Level-3 (“L3”) cache or Last Level Cache (“LLC”)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). The register file 806 may include general-purpose registers or other registers.

One or more processor(s) 802 are coupled with one or more interface bus(es) 810 to transmit communication signals such as address, data, or control signals between processor 802 and other components in system 800. The interface bus 810, in one embodiment, can be a processor bus, such as a version of a Direct Media Interface (“DMI”) bus. The interface bus 810 is not limited to a DMI bus, and may include one or more Peripheral Component Interconnect buses (e.g., PCI or PCI Express), memory busses, or other types of interface busses. The processor(s) 802 include an integrated memory controller 816 and a platform controller hub 830. The memory controller 816 facilitates communication between a memory device and other components of system 800, while platform controller hub (“PCH”) 830 provides connections to I/O devices via a local I/O bus.

A memory device 820 can be a dynamic random access memory (“DRAM”) device, a static random access memory (“SRAM”) device, flash memory device, phase-change memory device, or some other memory device having suitable performance to serve as process memory. The memory device 820 can operate as system memory for system 800, to store data 822 and instructions 821 for use when one or more processors 802 execute an application or process. The memory controller 816 also couples with an optional external graphics processor 612, which may communicate with one or more graphics processors 808 in processors 802 to perform graphics and media operations. A display device 811 can connect to the processor(s) 802. The display device 811 can include one or more of an internal display device, as in a mobile electronic device or a laptop device, or an external display device attached via a display interface (e.g., DisplayPort). The display device 811 may comprise a head mounted display (“HMD”) such as a stereoscopic display device for use in virtual reality (“VR”) applications or augmented reality (“AR”) applications.

A platform controller hub 830 enables peripherals to connect to memory device 820 and processor 802 via a high-speed I/O bus. I/O peripherals include, but are not limited to, an audio controller 846, a network controller 834, a firmware interface 828, a wireless transceiver 826, touch sensors 825, a data storage device 824 (hard disk drive, flash memory, etc.). The data storage device 824 can connect via a storage interface (e.g., SATA) or via a peripheral bus, such as a Peripheral Component Interconnect bus (e.g., PCI or PCI Express). The touch sensors 825 can include touch screen sensors, pressure sensors, or fingerprint sensors. The wireless transceiver 826 may be a Wi-Fi transceiver, a Bluetooth transceiver, or a mobile network transceiver, such as a 3G, 4G, or Long Term Evolution (“LTE”) transceiver. A firmware interface 828 enables communication with system firmware, and can be, for example, a unified extensible firmware interface (“UEFI”). A network controller 834 can enable a network connection to a wired network. A high-performance network controller (not shown) couples with the interface bus 810. An audio controller 846 is a multi-channel high definition audio controller. The system 800 includes an optional legacy I/O controller 840 for coupling legacy (e.g., Personal System 2 (PS/2)) devices to system. The platform controller hub 830 can also connect to one or more Universal Serial Bus (“USB”) controllers 842 connect input devices, such as keyboard and mouse 843 combinations, a camera 844, or other USB input devices.

An instance of memory controller 816 and platform controller hub 830 may be integrated into a discrete external graphics processor, such as an external graphics processor 812. The platform controller hub 830 and/or memory controller 616 may be external to one or more processor(s) 802. The system 800 can include an external memory controller 816 and platform controller hub 830, which may be configured as a memory controller hub and peripheral controller hub within a system chipset that is in communication with the processor(s) 802.

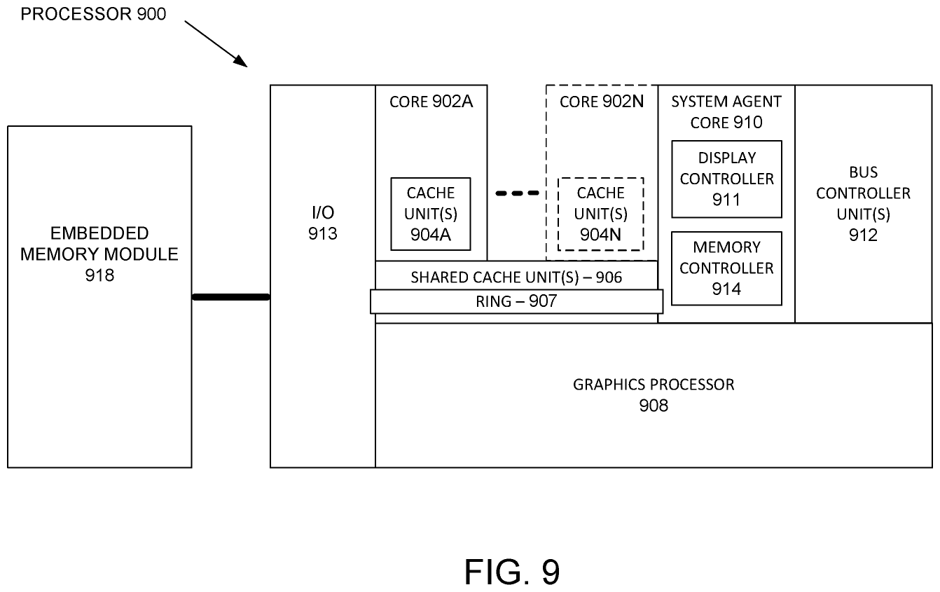

FIG. 9 is a block diagram of a processor 900 having one or more processor cores 902A-902N, an integrated memory controller 914, and an integrated graphics processor 908, according to at least one embodiment. The processor 900 can include additional cores up to, and including, additional core 902N represented by dashed lined boxes. Each of processor cores 902A-902N includes one or more internal cache units 904A-904N, and, in some illustrative embodiments, each processor core also has access to one or more shared cached units 906.

Internal cache units 904A-904N and shared cache units 906 represent a cache memory hierarchy within the processor 900. Cache memory units 904A-904N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. Cache coherency logic maintains coherency between various cache units 906 and 904A-904N.

The processor 900 may also include a set of one or more bus controller units 912 and a system agent core 910. The one or more bus controller units 916 manage a set of peripheral buses, such as one or more PCI or PCI express busses. The system agent core 910 provides management functionality for various processor components and includes one or more integrated memory controllers 914 to manage access to various external memory devices (not shown).

One or more of processor cores 902A-902N include support for simultaneous multi-threading. The system agent core 910 includes components for coordinating and operating cores 902A-902N during multi-threaded processing. The system agent core 910 may additionally include a power control unit (“PCU”), which includes logic and components to regulate one or more power states of processor cores 902A-902N and the graphics processor 908.

The graphics processor 908 couples with shared cache units 906, and system agent core 910, including one or more integrated memory controllers 914. The system agent core 910 also includes a display controller 911 to drive graphics processor output to one or more coupled displays. The display controller 911 may also be a separate module coupled with graphics processor 908 via at least one interconnect, or it may be integrated within graphics processor 908.

A ring-based interconnect unit 907 can be used to couple internal components of the processor 900. An alternative interconnect unit may be used, such as a point-to-point interconnect, a switched interconnect, or other techniques. In at least one embodiment, the graphics processor 908 couples with ring interconnect 907 via an I/O link 913. The I/O link 913 represents at least one of multiple varieties of I/O interconnects, including an on-package I/O interconnect, which facilitates communication between various processor components and a high-performance embedded memory module 918, such as an eDRAM module. Each of processor cores 902A-902N and graphics processor 908 use embedded memory modules 918 as a shared Last Level Cache.

The processor cores 902A-902N may be homogenous cores executing a common instruction set architecture. The processor cores 902A-902N can be heterogeneous in terms of instruction set architecture (“ISA”), where one or more of the processor cores 902A-902N execute a common instruction set, while one or more other cores of the processor cores 902A-902N execute a subset of a common instruction set or a different instruction set. The processor cores 902A-902N can be, additionally or alternatively, heterogeneous in terms of microarchitecture, where one or more cores having a relatively higher power consumption couple with one or more power cores having a lower power consumption. The processor 900 can be implemented on one or more chips or as an SoC integrated circuit.

Other variations are within spirit of present disclosure. Thus, while disclosed techniques are susceptible to various modifications and alternative constructions, certain illustrated embodiments thereof are shown in drawings and are described above detail. It should be understood, however, that there is no intention to limit disclosure to specific form or forms disclosed, but on the contrary, the intention is to cover all modifications, alternative constructions, and equivalents falling within spirit and scope of this disclosure, as defined in the appended claims.

Use of terms “a,” “an,” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of a term “set” (e.g., “a set of items”) or “subset,” unless otherwise noted or contradicted by context, is to be construed as a non-empty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is understood with context to present that an item, term, etc., may be either A or B or C, or any non-empty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, or {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, processes described herein (or variations and/or combinations thereof) are performed under control of one or more computer systems configured with executable instructions and are implemented as code (e.g., executable instructions, one or more computer programs or one or more applications) executing collectively on one or more processors, by hardware or combinations thereof. Code is stored on a computer-readable storage medium, for example, in form of a computer program comprising a plurality of instructions executable by one or more processors. A computer-readable storage medium is a non-transitory computer-readable storage medium that excludes transitory signals (e.g., a propagating transient electric or electromagnetic transmission), but includes non-transitory data storage circuitry (e.g., buffers, cache, and queues) within transceivers of transitory signals. Code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. Executable instructions are executed such that different instructions are executed by different processors—for example, a non-transitory computer-readable storage medium store instructions and a main CPU executes some of instructions while a GPU and/or a DPU executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in this specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In the present description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout the specification, terms such as “processing,” “computing,” “calculating,” “determining,” or the like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission, or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be any processor capable of general purpose processing such as a CPU, GPU, or DPU. As non-limiting examples, “processor” may be any microcontroller or dedicated processing unit such as a DSP, an image signal processor (“ISP”), an arithmetic logic unit (“ALU”), a vision processing unit (“VPU”), a tree traversal unit (“TTU”), a ray tracing core, a tensor tracing core, a tensor processing unit (“TPU”), an embedded control unit (“ECU”), and the like. As non-limiting examples, “processor” may be a hardware accelerator, such as a programmable vision accelerator (“PVA”), deep learning accelerator (“DLA”), etc. As non-limiting examples, “processor” may also include one or more virtual instances of a CPU, GPU, etc., hosted on an underlying hardware component executing one or more virtual machines. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present the document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface (“API”). In some implementations, a process of obtaining, acquiring, receiving, or inputting analog or digital data can be accomplished by transferring data via a serial or parallel interface. In another implementation, a process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface, or an inter-process communication mechanism.

Although discussion above sets forth example implementations of described techniques, other architectures may be used to implement described functionality and are intended to be within scope of this disclosure. Furthermore, although specific distributions of responsibilities are defined above for purposes of discussion, various functions and responsibilities might be distributed and divided in different ways, depending on circumstances. And, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method comprising:
determining a location of at least one feature of interest depicted in a frame;
generating a bounding shape corresponding to the at least one feature of interest;
determining, based at least on the bounding shape, cropping information corresponding to the frame;
cropping, based at least on the cropping information, the frame to generate a cropped frame; and
encoding the cropped frame and the cropping information for transmission in at least one bitstream.

2. The computer-implemented method of claim 1, wherein the cropping information includes at least one of a dimension of the bounding shape or a position of the bounding shape within the frame.

3. The computer-implemented method of claim 2, wherein another dimension of another bounding shape is determined for another frame in a same video content stream as the frame, the dimension being different from the another dimension.

4. The computer-implemented method of claim 1, wherein the cropping information is encoded in the at least one bitstream as supplemental enhancement information (“SEI”).

5. The computer-implemented method of claim 1, wherein the encoding of the cropping information causes a decoder to generate a decoded representation of the at least one feature of interest based at least on the cropping information.

6. The computer-implemented method of claim 1, wherein the generating the bounding shape includes applying at least one non-linear exponential equation to determine movement of at least one of the bounding shape or a tracking window corresponding to the at least one feature of interest.

7. The computer-implemented method of claim 1, wherein the generating the bounding shape includes resizing a prior bounding shape corresponding to one or more prior frames based at least on one or more of a zoom operation or a pan operation with respect to the at least one feature of interest.

8. The computer-implemented method of claim 7, further comprising:
maintaining the at least one feature of interest within the bounding shape across a plurality of frames including the frame at least by dynamically resizing the bounding shape for at least one frame of the plurality of frames.

9. The computer-implemented method of claim 1, wherein the cropping information includes a position of the bounding shape within the frame, and wherein the cropping information is used after decoding to position at least a portion of the cropped frame within a composited frame according to the position of the bounding shape within the frame.

10. The computer-implemented method of claim 1, wherein the video content stream is encoded to be at least substantially compliant with at least one video compression standard from a group of video compression standards comprising: H.264/MPEG-4 Advanced Video Coding (“AVC”), H.265/High Efficiency Video Encoding (“HEVC”), VP8, VP9, AV1, Versatile Video Coding (“VVC”), or MPEG-5/Essential Video Compression (“EVC”).

11. The computer-implemented method of claim 1, further comprising:
applying at least a portion of data from the bitstream to the neural network to cause the neural network to perform at least one of video frame inferencing, video frame generation, video frame reconstruction, or adjustment of a two-dimensional or three-dimensional characteristic of the object of interest.

12. A system comprising:
one or more processing units to:
receive encoded data representative of a cropped frame and cropping information corresponding to the cropped frame, the cropped frame being cropped based at least on a dimension of a variably sized bounding shape associated with one or more features of a subject depicted using the cropped frame;
decode the encoded data to generate decoded data representative of the cropped frame and the cropping information; and
composite at least a portion of the cropped frame as foreground in a composited frame at a position determined based at least on the cropping information.

13. The system of claim 12, wherein the system comprises at least one of:
a system for performing simulation operations;
a system for performing simulation operations to test or validate autonomous machine applications;
a system for performing light transport simulation;
a system for rendering graphical output;
a system using one or more multi-dimensional assets at least partially generated using a collaborative content creation platform;
a system implementing digital twin simulation;
a system for performing deep learning operations;
a system implemented using an edge device;
a system incorporating one or more virtual machines (“VMs”);
a system implemented at least partially in a data center; or
a system implemented at least partially using cloud computing resources.

14. The system of claim 12, wherein the cropping information includes at least one of a dimension of the bounding shape or a position of the bounding shape within an original frame corresponding to the cropped frame.

15. The system of claim 12, wherein the cropping information is included in the encoded data as supplemental enhancement information (“SEI”).

16. The system of claim 12, wherein the position of the cropped frame within the composited frame corresponds to a position of the variably sized bounding shape within an original frame corresponding to the cropped frame.

17. A processor comprising:
one or more processing units to generate a composite image based at least on data representative of a cropped image and cropping information corresponding to the cropped image, the composite image being generated such that at least a portion of the cropped image is included in the composite image at a position and a relative size determined based at least on the cropping information.

18. The processor of claim 17, wherein the cropping information includes at least one of a dimension of a bounding shape or a position of the bounding shape within an original frame corresponding to the cropped image.

19. The processor of claim 17, wherein the cropping information is received as a supplemental enhancement information (“SEI”) message.

20. The processor of claim 17, wherein composite image corresponds to one of a video conferencing application or a gaming application.
